(19) United States
(12) Patent Application Publication
(10) Pub. No.: US 2025/0094798 A1
(43) Pub. Date: Mar. 20, 2025

(54) Partitioned Inference And Training Of Large Models

(71) Applicant: Google LLC, Mountain View, CA (US)

(72) Inventors: Li Zhang, Kirkland, WA (US); Matthew Sharifi, Kilchberg (CH); David Petrou, Brooklyn, NY (US); Blaise Aguera y Arcas, Seattle, WA (US)

(21) Appl. No.: 18/727,800

(22) PCT Filed: Feb. 3, 2022
(86) PCT No.: PCT/US22/15090

§ 371 Date: Jul. 10, 2024

(51) Int. Cl. G06N 3/08

(52) U.S. Cl. CPC G06N 3/08

(57) ABSTRACT

Systems and methods for partitioning a large model that has been configured to use a model-synthesis approach in which multiple basis models are combined to generate a final output. The present technology provides systems and methods for identifying a device-specific or subject-specific subset of those basis models to be used on a given device, such that it need not store the weight matrices for the entire set of basis models, and may perform inference using only the weight matrices of the identified subset of basis models. In some examples, the subset of basis models used by a given device may be updated based on actual usage and feedback. Likewise, in some examples, the model may be trained in a federated setting in which multiple devices each utilize different subsets of the basis models, and share training signals with a full copy of the model.

### BACKGROUND

As advances in machine learning continue to expand the capabilities of models of all types, the range of potential applications for such models likewise expands. However, these advances are also producing models that are often too large and/or too computationally expensive to run on many devices (e.g., consumer products with constrained memory space and/or limited processing power, such as personal computers, mobile phones, tablets, smart home devices, etc.).

### BRIEF SUMMARY

The present technology concerns systems and methods for partitioning a large model into a smaller model that may be retained on a given device, (e.g., a resource-constrained device with constrained memory space and/or limited processing power, such as a personal computer, mobile phone, tablet, smart home device, etc.). The large model may be any suitable type of model (e.g., language model, vision classification model, speech recognition model, etc.) that has been configured to use a model-synthesis approach in which outputs from multiple basis models are combined to generate a final output. For example, the large model may be large language model (e.g., T5, Gopher, LaMDA) which has been extended using a “BasisNet” approach, as set forth below, such that its final prediction is generated by synthesizing the outputs of multiple basis models, each of which share the same architecture, but differ as to one or more of their weight parameters. The present technology provides systems and methods for identifying a device-specific or subject-specific subset of those basis models to be included on the given device, such that the given device does not need to store the weight matrices for the entire set of basis models, and may perform inference using only the weight matrices of the identified subset of basis models. In some examples, the present technology also provides systems and methods for updating the subset of basis models on the given device based on actual usage and feedback. Likewise, in some examples, the present technology provides systems and methods for training the model in a federated setting in which multiple devices each utilize different subsets of the basis models, and share training signals with a full copy of the model.

In one aspect, the disclosure describes a computer-implemented method, comprising: training a full model having one or more layers, each layer of the one or more layers of the full model having a first plurality of basis models, wherein the training comprises: (1) for each given first training example of a set of first training examples: identifying, using one or more processors of a processing system, a first embedding vector for each layer of the one or more layers of the full model based on the given first training example, each identified first embedding vector comprising a first set of combination coefficients; processing, using the one or more processors, the first embedding vector identified for each layer to generate a second embedding vector for each layer, each generated second embedding vector comprising a second set of combination coefficients, at least a predetermined number of combination coefficients in the second set of combination coefficients having a value of zero; generating, using the full model, an output from each given layer of the one or more layers of the full model, the output for the given layer being based upon the first plurality of basis models of the given layer, the second embedding vector generated for the given layer, and the given first training example or an output of another layer of the one or more layers of the full model; generating, using the full model, a first prediction based on one or more of the generated outputs; and comparing, using the one or more processors, the first prediction to the given first training example to generate a first loss value; and (2) modifying, using the one or more processors, one or more parameters of the full model based at least in part on the generated first loss values. In some aspects, for each given layer of the one or more layers of the full model, the first set of combination coefficients includes a combination coefficient associated with each basis model of the first plurality of basis models of the given layer. In some aspects, generating the output from the given layer comprises, for each given basis model of the first plurality of basis models of the given layer: generating a first vector from the given basis model based on the given first training example or an output of another layer of the one or more layers of the full model; and modifying the first output using one of the combination coefficients of the second set of combination coefficients of the second embedding vector generated for the given layer to generate a second vector. In some aspects, generating the output from the given layer further comprises combining each second vector generated for each basis model of the first plurality of basis models of the given layer. In some aspects, each second vector generated for each basis model of the first plurality of basis models of the given layer comprises is combined using a linear combination. In some aspects, the full model further includes a first lightweight model or a first embedding function, and the first lightweight model or the first embedding function is configured to identify the first embedding vector for each layer of the one or more layers of the full model. In some aspects, the method further comprises training a partitioned model having one or more layers, each given layer of the one or more layers of the partitioned model having a second plurality of basis models that is a subset of the first plurality of basis models for the given layer, wherein the training comprises: (1) for each given second training example of a set of second training examples: identifying, using the one or more processors, a third embedding vector for each layer of the one or more layers of the partitioned model, each identified third embedding vector comprising a third set of combination coefficients, at least a predetermined number of combination coefficients in the third set of combination coefficients having a value of zero; generating, using the partitioned model, an output from each given layer of the one or more layers of the partitioned model, the output for the given layer being based upon the second plurality of basis models of the given layer, the third embedding vector identified for the given layer, and the given second training example or an output of another layer of the one or more layers of the partitioned model; generating, using the partitioned model, a second prediction based on one or more of the generated outputs; and comparing, using the one or more processors, the second prediction to the given second training example to generate a second loss value; and (2) modifying, using the one or more processors, one or more parameters of the partitioned model based at least in part on the generated second loss values. In some aspects, the partitioned model further includes a second lightweight model or a second embedding function, and the second lightweight model or the second embedding function is configured to identify the third embedding vector for each layer of the one or more layers of the partitioned model. In some aspects, modifying one or more parameters of the partitioned model based at least in part on the generated second loss values comprises modifying one or more parameters of the second lightweight model or the second embedding function. In some aspects, the partitioned model further includes a set of third embedding vectors and data associating a third embedding vector of the set of third embedding vectors with each layer of the one or more layers of the partitioned model, and identifying the third embedding vector for each layer of the one or more layers of the partitioned model comprises selecting the third embedding vector associated with each layer of the one or more layers of the partitioned model based on the data. In some aspects, the set of third embedding vectors includes a single third embedding vector, and the data associates the single third embedding vector with every layer of the one or more layers of the partitioned model. In some aspects, modifying one or more parameters of the partitioned model based at least in part on the generated second loss values comprises modifying one or more of the third embedding vectors. In some aspects, the method further comprises: determining, using the one or more processors, that modifying one or more parameters of the partitioned model based at least in part on the generated second loss values results in a given combination coefficient of the third set of combination coefficients changing in value from zero to a non-zero value; retrieving, using the one or more processors, a copy of a given basis model of the first plurality of basis models based on the given combination coefficient changing in value from zero to a non-zero value; and including the given basis model in the second plurality of basis models. In some aspects, the one or more processors are configured to retrieve the copy of the given basis model from a device storing the full model. In some aspects, the method further comprises: determining, using the one or more processors, that modifying one or more parameters of the partitioned model based at least in part on the generated second loss values results in a given combination coefficient of the third set of combination coefficients changing in value from a non-zero value to zero; and removing, using the one or more processors, a given basis model from the second plurality of basis models based on the given combination coefficient changing in value from a non-zero value to zero. In some aspects, the method further comprises caching, using the one or more processors, a copy of the given basis model.

In another aspect, the disclosure describes a computer-implemented method, comprising: training a partitioned model having one or more layers, each given layer of the one or more layers of the partitioned model having a first plurality of basis models, wherein the training comprises: (1) for each given first training example of a set of first training examples: identifying, using one or more processors of a processing system, a first embedding vector for each layer of the one or more layers of the partitioned model, each identified first embedding vector comprising a first set of combination coefficients, at least a predetermined number of combination coefficients in the first set of combination coefficients having a value of zero; generating, using the partitioned model, an output from each given layer of the one or more layers of the partitioned model, the output for the given layer being based upon the first plurality of basis models of the given layer, the first embedding vector identified for the given layer, and the given first training example or an output of another layer of the one or more layers of the partitioned model; generating, using the partitioned model, a first prediction based on one or more of the generated outputs; and comparing, using the one or more processors, the first prediction to the given first training example to generate a first loss value; and (2) modifying, using the one or more processors, one or more parameters of the partitioned model based at least in part on the generated first loss values. In some aspects, the partitioned model further includes a first lightweight model or a first embedding function, and the first lightweight model or the first embedding function is configured to identify the first embedding vector for each layer of the one or more layers of the partitioned model. In some aspects, modifying one or more parameters of the partitioned model based at least in part on the generated first loss values comprises modifying one or more parameters of the first lightweight model or the first embedding function. In some aspects, the partitioned model further includes a set of first embedding vectors and data associating a first embedding vector of the set of first embedding vectors with each layer of the one or more layers of the partitioned model, and identifying the first embedding vector for each layer of the one or more layers of the partitioned model comprises selecting the first embedding vector associated with each layer of the one or more layers of the partitioned model based on the data. In some aspects, the set of first embedding vectors includes a single first embedding vector, and the data associates the single first embedding vector with every layer of the one or more layers of the partitioned model. In some aspects, modifying one or more parameters of the partitioned model based at least in part on the generated first loss values comprises modifying one or more of the first embedding vectors. In some aspects, the method further comprises: determining, using the one or more processors, that modifying one or more parameters of the partitioned model based at least in part on the generated first loss values results in a given combination coefficient of the first set of combination coefficients changing in value from zero to a non-zero value; retrieving, using the one or more processors, a copy of a given basis model based on the given combination coefficient changing in value from zero to a non-zero value; and including the given basis model in the first plurality of basis models. In some aspects, the one or more processors are configured to retrieve the copy of the given basis model from a device storing a second plurality of basis models. In some aspects, the method further comprises: determining, using the one or more processors, that modifying one or more parameters of the partitioned model based at least in part on the generated first loss values results in a given combination coefficient of the first set of combination coefficients changing in value from a non-zero value to zero; and removing, using the one or more processors, a given basis model from the first plurality of basis models based on the given combination coefficient changing in value from a non-zero value to zero. In some aspects, the method further comprises caching, using the one or more processors, a copy of the given basis model. In some aspects, modifying one or more parameters of the partitioned model based at least in part on the generated first loss values comprises modifying one or more of the first embedding vectors to generate a second embedding vector for each layer of the one or more layers of the partitioned model, each second embedding vector comprising a second set of combination coefficients, at least a predetermined number of combination coefficients in the second set of combination coefficients having a value of zero, and the method further comprises, for each given first inference task of a set of first inference tasks: generating, using the partitioned model, a first output from each given layer of the one or more layers of the partitioned model, the first output for the given layer being based upon the first plurality of basis models of the given layer, the second embedding vector generated for the given layer, and the given first inference task or a first output of another layer of the one or more layers of the partitioned model; and generating, using the partitioned model, a second prediction based on one or more of the generated first outputs.

In another aspect, the disclosure describes a processing system comprising one or more processors configured to carry out any of the methods set forth above and described further below.

In another aspect, the disclosure describes a computer program product comprising computer readable instructions that, when executed by a processing system, cause the processing system to perform any of the methods set forth above and described further below.

In another aspect, the disclosure describes a full model trained according to any of the methods set forth above and described further below.

In another aspect, the disclosure describes a partitioned model trained according to any of the methods set forth above and described further below.

### BRIEF DESCRIPTION OF THE DRAWINGS

FIG. 1 is a functional diagram of an example system in accordance with aspects of the disclosure.

FIG. 2 is a functional diagram of an example system in accordance with aspects of the disclosure.

FIGS. 3A-3C are flow diagrams illustrating how exemplary full models configured to use a model-synthesis approach may process an input to generate a final prediction, in accordance with aspects of the disclosure.

FIGS. 4A-4C are flow diagrams illustrating how exemplary partitioned models configured to use a model-synthesis approach may process an input to generate a final prediction, in accordance with aspects of the disclosure.

FIG. 5 sets forth an exemplary method for training a full model to generate predictions based on a sparse set of combination coefficients, in accordance with aspects of the disclosure.

FIG. 6 sets forth an exemplary method for training a partitioned model to generate predictions based on a sparse set of combination coefficients and to update its set of basis models, in accordance with aspects of the disclosure.

FIG. 7 sets forth an exemplary method for training a partitioned model to generate predictions based on a sparse set of combination coefficients and to update its set of basis models, in accordance with aspects of the disclosure.

### DETAILED DESCRIPTION

The present technology will now be described with respect to the following exemplary systems and methods. Reference numbers in common between the figures depicted and described below are meant to identify the same features.

### Example Systems

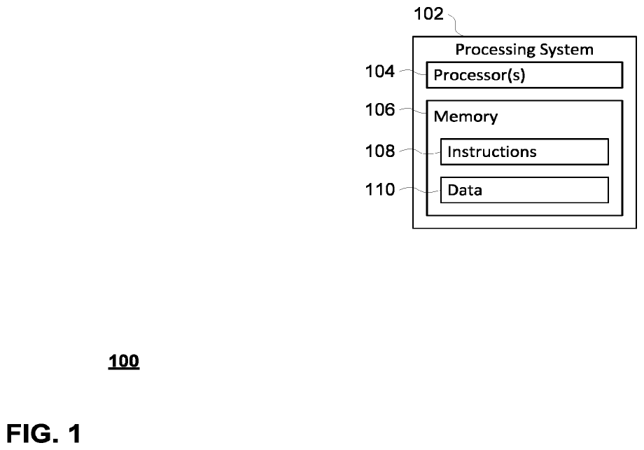

FIG. 1 shows a high-level system diagram 100 of an exemplary processing system 102 for performing the methods described herein. The processing system 102 may include one or more processors 104 and memory 106 storing instructions 108 and data 110. The instructions 108 and data 110 may include a full model configured to use a model-synthesis approach in which multiple basis models are combined to generate a final output. For example, the instructions 108 and data 110 may include a large language model (e.g., T5, Gopher, LaMDA) which has been extended using a “BasisNet” approach, as set forth below, such that its final prediction is generated by synthesizing the outputs of multiple basis models, each of which may share the same architecture, but differ as to one or more of their weight parameters. In addition, the data 110 may store training examples to be used in training the full model (e.g., those used in pre-training or fine-tuning), training signals and/or loss values provided by one or more client devices (e.g., devices hosting a partitioned model comprising a subset of the basis models), etc.

Processing system 102 may be resident on a single computing device. For example, processing system 102 may be a server, personal computer, or mobile device, and the full model and one or more partitioned models may thus be local to that single computing device. Similarly, processing system 102 may be resident on a cloud computing system or other distributed system. In such a case, the full model and one or more partitioned models may be distributed across two or more different physical computing devices. For example, in some aspects of the technology, the processing system may comprise a first computing device storing the full model, and a second computing device storing a partitioned model. In such cases, the second computing device may be one with a constrained memory space, e.g. a limited amount of memory for storing and running programs, and/or limited processing power. Likewise, in some aspects of the technology, the processing system may comprise a first computing device storing layers 1-n of a full model having m layers, a second computing device storing layers n-m of the full model, a third computing device storing the training examples used to train the full model, and a fourth computing device (e.g., a personal computer, tablet, mobile phone) storing a partitioned model. Here as well, in such cases, the fourth computing device may be one with a constrained memory space, e.g. a limited amount of memory for storing and running programs, and/or limited processing power. Further, in some aspects of the technology, the partitioned model may also be distributed across two or more computing devices. For example, the partitioned model may be stored partially on a user's phone (e.g., the phone may store the weight matrices for basis models 1-100, or layers 1-n of the partitioned model, etc.), and partially on the user's smart watch (e.g., the smart watch may store the weight matrices for basis models 101-110, or layers n-m of the partitioned model, etc.).

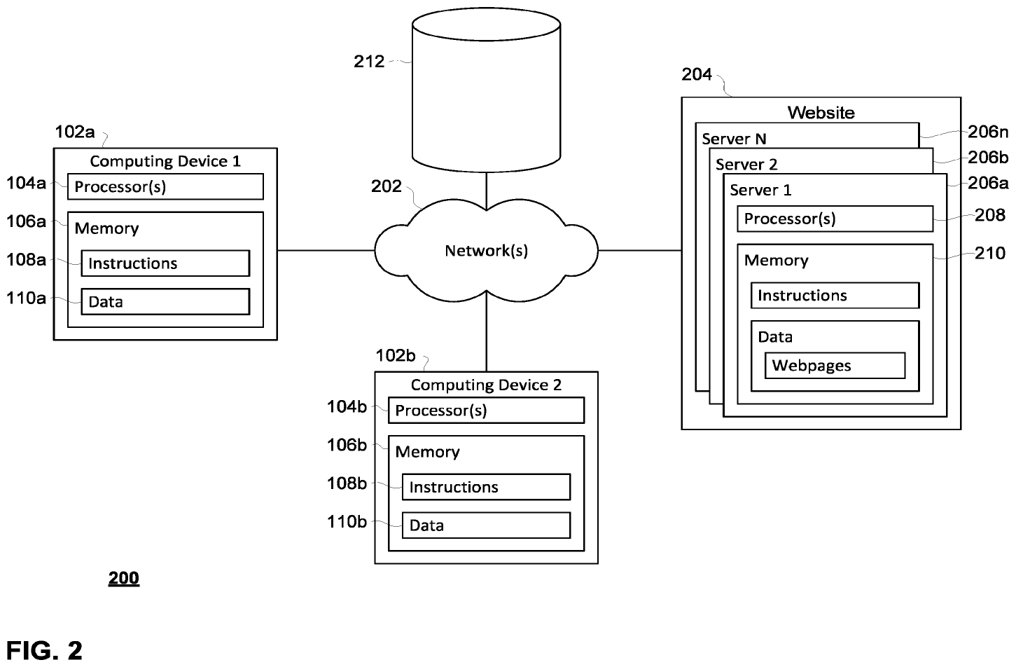

Further in this regard, FIG. 2 shows a high-level system diagram 200 in which the exemplary processing system 102 just described is distributed across two computing devices 102a and 102b, each of which may include one or more processors (104a, 104b) and memory (106a, 106b) storing instructions (108a, 108b) and data (110a, 110b). The processing system 102 comprising computing devices 102a and 102b is shown being in communication with one or more websites and/or remote storage systems over one or more networks 202, including website 204 and remote storage system 212. In this example, website 204 includes one or more servers 206a-206n. Each of the servers 206a-206n may have one or more processors (e.g., 208), and associated memory (e.g., 210) storing instructions and data, including the content of one or more webpages. Likewise, although not shown, remote storage system 212 may also include one or more processors and memory storing instructions and data. In some aspects of the technology, the processing system 102 comprising computing devices 102a and 102b may be configured to retrieve data from one or more of website 204 and/or remote storage system 212, for use in training the full model and/or one or more partitioned models. For example, in some aspects, the first computing device 102a may be configured to retrieve training examples from the remote storage system 212 for use in pre-training or fine-tuning of a full model housed on the first computing device 102a. In some aspects of the technology, the first computing device 102a may also be further configured to retrieve device-specific training examples or other data from the second computing device 102b for use in further training the full model and identifying a device-specific or subject-specific subset of basis models. As discussed further below, a partitioned model including the identified device-specific or subject-specific subset of basis models may then be provided to the second computing device 102b, where it may be stored in memory 106b.

The processing systems described herein may be implemented on any type of computing device(s), such as any type of general computing device, server, or set thereof, and may further include other components typically present in general purpose computing devices or servers. Likewise, the memory of such processing systems may be of any non-transitory type capable of storing information accessible by the processor(s) of the processing systems. For instance, the memory may include a non-transitory medium such as a hard-drive, memory card, optical disk, solid-state, tape memory, or the like. Computing devices suitable for the roles described herein may include different combinations of the foregoing, whereby different portions of the instructions and data are stored on different types of media.

In all cases, the computing devices described herein may further include any other components normally used in connection with a computing device such as a user interface subsystem. The user interface subsystem may include one or more user inputs (e.g., a mouse, keyboard, touch screen and/or microphone) and one or more electronic displays (e.g., a monitor having a screen or any other electrical device that is operable to display information). Output devices besides an electronic display, such as speakers, lights, and vibrating, pulsing, or haptic elements, may also be included in the computing devices described herein.

The one or more processors included in each computing device may be any conventional processors, such as commercially available central processing units (“CPUs”), graphics processing units (“GPUs”), tensor processing units (“TPUs”), etc. Alternatively, the one or more processors may be a dedicated device such as an ASIC or other hardware-based processor. Each processor may have multiple cores that are able to operate in parallel. The processor(s), memory, and other elements of a single computing device may be stored within a single physical housing, or may be distributed between two or more housings. Similarly, the memory of a computing device may include a hard drive or other storage media located in a housing different from that of the processor(s), such as in an external database or networked storage device. Accordingly, references to a processor or computing device will be understood to include references to a collection of processors or computing devices or memories that may or may not operate in parallel, as well as one or more servers of a load-balanced server farm or cloud-based system.

The computing devices described herein may store instructions capable of being executed directly (such as machine code) or indirectly (such as scripts) by the processor(s). The computing devices may also store data, which may be retrieved, stored, or modified by one or more processors in accordance with the instructions. Instructions may be stored as computing device code on a computing device-readable medium. In that regard, the terms “instructions” and “programs” may be used interchangeably herein. Instructions may also be stored in object code format for direct processing by the processor(s), or in any other computing device language including scripts or collections of independent source code modules that are interpreted on demand or compiled in advance. By way of example, the programming language may be C#, C++, JAVA or another computer programming language. Similarly, any components of the instructions or programs may be implemented in a computer scripting language, such as JavaScript, PHP, ASP, or any other computer scripting language. Furthermore, any one of these components may be implemented using a combination of computer programming languages and computer scripting languages.

### Example Methods

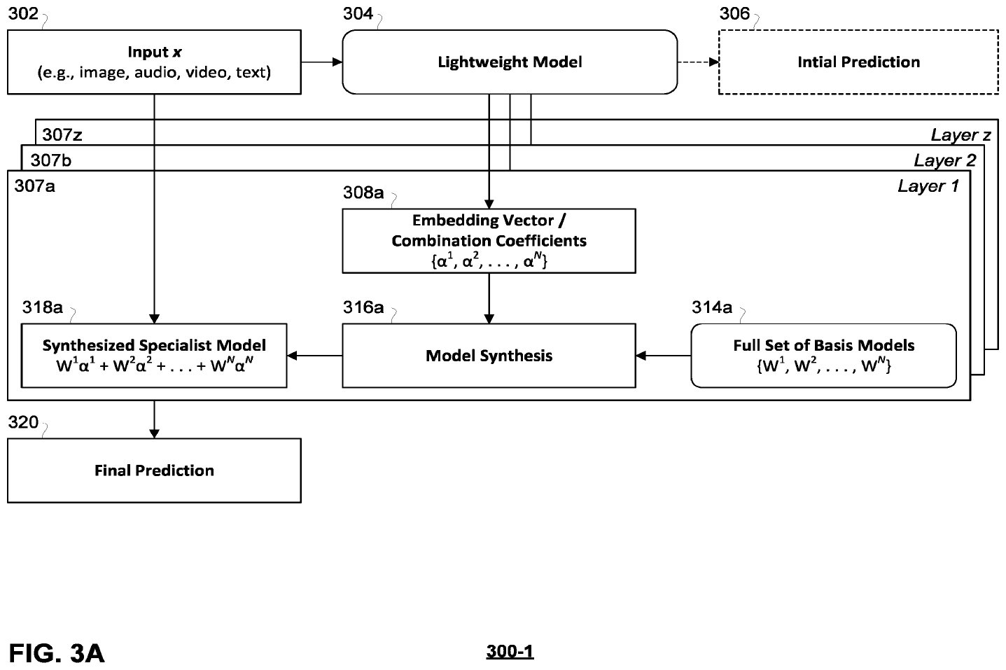

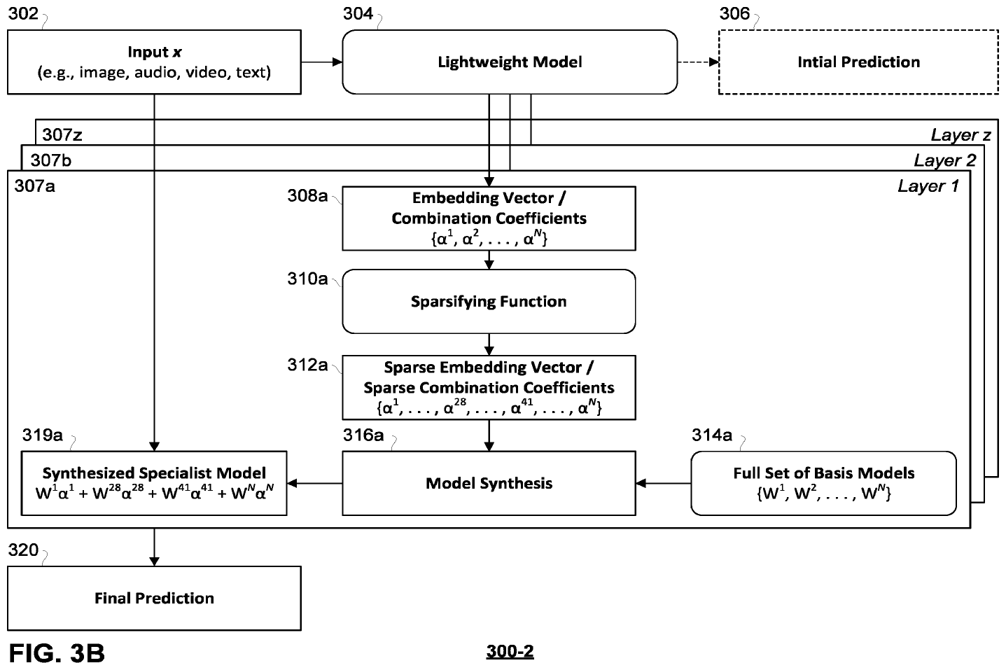

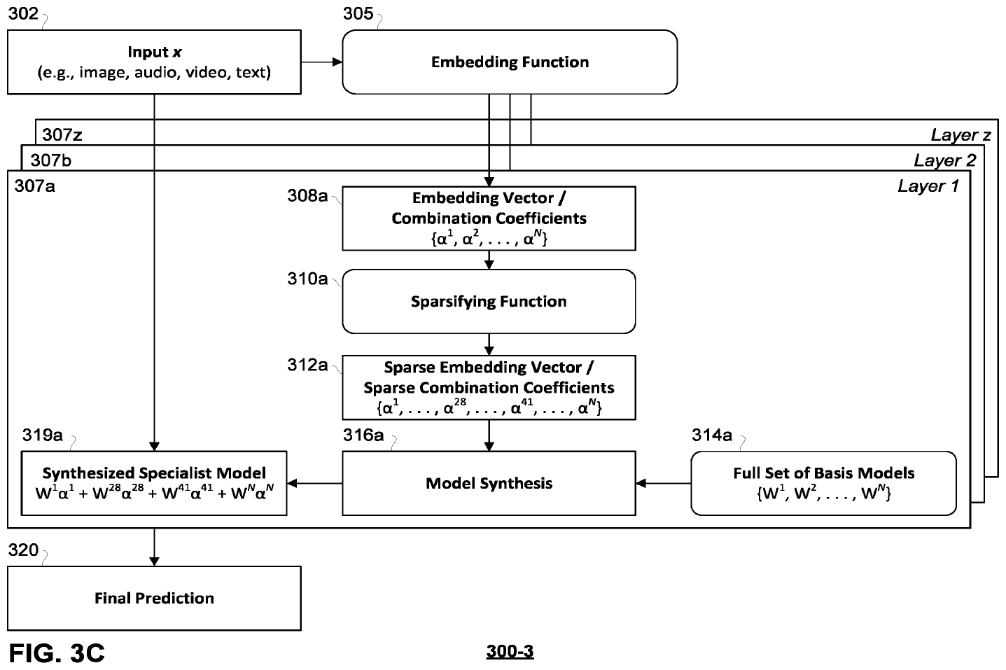

FIGS. 3A-3C are flow diagrams 300-1, 300-2, and 300-3 illustrating how different exemplary full models configured to use a model-synthesis approach may process an input to generate a final prediction, in accordance with aspects of the disclosure.

FIG. 3A shows one example of how an input x (302) may be processed using an exemplary full model that includes a lightweight model 304. Input x (302) may be any type of input that the full model is configured to process, such as image data (e.g., a photograph, pixel data), audio data (e.g., music, a spoken utterance), video data (e.g., a movie with video with audio, a silent movie), text data (e.g., a sequence of characters, a sequence of words), etc. The flow depicted in FIG. 3A is consistent with the “BasisNet” approach described in International Patent Application No. PCT/US21/43655, filed on Jul. 29, 2021, and “BasisNet: Two-stage Model Synthesis for Efficient Inference” (M. Zhang et al., arXiv: 2105.03014v1), the entire disclosures of which are incorporated by reference herein. In some aspects of the technology, the lightweight model 304 may be incorporated into the full model. Likewise, in some aspects, the lightweight model 304 may be stored on a different computing device than the full model, and may be configured to transmit its outputs to the full model.

As shown in the example of FIG. 3A, the lightweight model 304 may be configured to generate an embedding vector representing a set of combination coefficients {α1, α2, . . . , αN} for each of the full model's layers 1 through z (307a, 307b, . . . 307z). In some aspects of the technology, the generated embedding vector may be different for every layer of the full model. In some aspects, the same generated embedding vector may be used for every layer of the full model. In some aspects, some layers of the full model may use the same generated embedding vector, while other layers of the full model may use different embedding vectors. In some aspects of the technology, the sets of combination coefficients for each of the full model's layers 1 through z (307a, 307b, . . . 307z) may be included in separate embedding vectors for each layer. In some aspects of the technology, the sets of combination coefficients for each of the full model's layers 1 through z (307a, 307b, . . . 307z) may be combined into a single embedding vector for the full model.

In each layer of the full model, the embedding vector (e.g., 308a) may be used to combine a full set of basis models W¹ through W^{N} (e.g., 314a) into a synthesized specialist model (e.g., 318a). For example, in layer 1 (307a), this process is shown as taking place in the model synthesis block 316a using linear combination, resulting in a synthesized specialist model 318a of W¹α¹+W²α²+ . . . +W^{N}α^{N}. However, any suitable type of combination may be employed by model synthesis block 316a. In addition, the type of combination used by the model synthesis block of each layer may be unique to that layer, or may be the same as that which is used in one or more of the other layers of the full model. Likewise, the full set of basis models (e.g., 314a) used in each layer may be unique to that layer, or may be the same as that which is used in one or more of the other layers of the full model.

In the example of FIG. 3A (and in the examples of FIGS. 3B and 3C, described below), it is assumed that all basis models in each of layers 1 through z will share the same architecture, and will differ only as to one or more of their weight parameters. However, in some aspects of the technology, each given layer of the full model may have a full set of basis models (e.g., 314a) in which each individual basis model has same architecture and differs only in its respective weights, but the architecture of the basis models in one or more layers may be different than the architecture of the basis models in another layer of the full model. Further, in some aspects, some or all of the basis models used in a given layer of the full model may have different architectures than other basis models in that same layer. Thus, in some aspects of the technology, one or more layers of the full model may have a full set of basis models in which every basis model has a unique architecture.

Once the synthesized specialist model has been generated for a given layer, it may be used to create an output based directly or indirectly on the input x (302). In that regard, in the example of FIG. 3A, it is assumed that the synthesized specialist model 318a of layer 1 (307a) will generate a first output based directly on input x (302), and that the first output will be passed to the next layer, where the synthesized specialist model 318b (not shown) of layer 2 (307b) will then generate a second output based on the first output. This process may then continue until layer z (307z), where the output generated by synthesized specialist model 318z (not shown) may be used as the final prediction 320. However, in some aspects of the technology, each layer (307a, 307b, . . . 307z) may be configured to generate its respective output based directly on input x (302). Likewise, in some aspects of the technology, layers 2 through z (307b-307z) of the full model may be configured to generate their respective outputs based on input x (302) and the output of one or more prior layers of the full model. Further, in some aspects of the technology, the final prediction 320 of the full model may be based directly or indirectly on the output of layer z (307z) of the full model, or may be based on any suitable combination of outputs from two or more layers of the full model. For example, in some aspects of the technology, final prediction 320 may be a weighted linear combination of the outputs of every synthesized specialist model of every layer (307a-307z) of the full model.

Final prediction 320 may be in any suitable form. Thus, where the input x (302) comprises image data (e.g., pixel data), the final prediction 320 may comprise classification data indicative of a particular class or group of classes to which the image belongs within a plurality of classes. Further, in some aspects, the classification data may comprise a distribution over the plurality of classes. For example, each class of the plurality of classes may represent a respective object type, and the final prediction 320 may comprise scores for each class indicating whether any object in that class is predicted to be present in the image. Likewise, where the input x (302) comprises audio data of a spoken utterance, the final prediction 320 may comprise a transcription of the spoken utterance. Further, where the input x (302) comprises a sequence of text, the final prediction 320 may be another sequence of text. For example, the input x (302) may be the text of a user's request to an automated assistant, and the final prediction 320 may be a generated text response to the user's request. Likewise, the input x (302) may be text in a first language, and the final prediction 320 may be a translation of the input text into a second language.

As shown in FIG. 3A, the lightweight model 304 may also optionally be configured to generate an initial prediction 306. This initial prediction 306 may further include a confidence value. Thus, in some aspects of the technology, the full model may be configured to forego processing input x through layers 1 through z (307a-307z) where the lightweight model 304 produces an initial prediction 306 based on input x that has a confidence value that exceeds a predetermined threshold (e.g., 80%, 85%, 90%, 95%, 99%, etc.). For example, where the full model is configured to classify images, and the lightweight model is able to classify image x as being a picture of a husky with a confidence of 91%, the full model may be configured not to process image x through the layers 1 through z in order to generate a final prediction 320.

FIG. 3B also shows an exemplary full model that employs a lightweight model 304 to generate an initial embedding vector representing a set of combination coefficients (e.g., 308a) for each of the layers (307a, 307b, . . . 307z), and to optionally generate an initial prediction 306, as described above with respect to FIG. 3A. However, in the example of FIG. 3B, the initial embedding vector generated by the lightweight model 304 is further processed with a sparsifying function (e.g., 310a) to generate a sparse embedding vector representing a sparse set of combination coefficients (e.g., 312a). The sparsifying function 310a may be any suitable function that ensures that a predetermined number of the elements of the sparse embedding vector have a value of zero and/or that a predetermined number of the elements of the sparse embedding vector have a non-zero value. For example, sparsifying function 310a may be a modified softmax activation function configured to output probabilities that are k sparse or no greater than k sparse (e.g., Sparsemax), a function configured to generate a sparse embedding vector (e.g. 312a) from the k largest elements of the initial embedding vector (e.g., 310a), a function that generates a sparse embedding vector (e.g. 312a) from a random selection of k elements of the initial embedding vector (e.g., 310a), etc. In addition, the type of sparsifying function used by the sparsifying function block of each layer may be unique to that layer, or may be the same as that which is used in one or more of the other layers of the full model.

As above, in each layer of the full model of FIG. 3B, the sparse embedding vector (e.g., 312a) may be used to combine a full set of basis models W¹ through W^{N} (e.g., 314a) into a synthesized specialist model (e.g., 319a). For example, in layer 1 (307a), this process is shown as taking place in the model synthesis block 316a using linear combination, resulting in a synthesized specialist model 319a of W¹α¹+W²⁸α²⁸+W⁴¹α⁴¹+W^{N}α^{N}. Because model synthesis block 316a does this based on the sparse embedding vector 312a, the resulting synthesized specialist model 319a is simpler than the synthesized specialist model 318a of layer 1 (307a) of FIG. 3A. Here as well, any suitable type of combination may be employed by model synthesis block 316a. In addition, the type of combination used by the model synthesis block of each layer may be unique to that layer, or may be the same as that which is used in one or more of the other layers of the full model. Likewise, the full set of basis models (e.g., 314a) used in each layer may be unique to that layer, or may be the same as that which is used in one or more of the other layers of the full model.

As shown in FIG. 3B as well, once the synthesized specialist model has been generated for a given layer, it may be used to create an output based directly or indirectly on the input x (302). Thus, in the example of FIG. 3B, it is also assumed that the synthesized specialist model 319a of layer 1 (307a) will generate a first output based directly on input x (302), and that the first output will be passed to the next layer, where the synthesized specialist model 319b (not shown) of layer 2 (307b) will then generate a second output based on the first output. This process may then continue until layer z (307z), where the output generated by synthesized specialist model 319z (not shown) may be used as the final prediction 320. However, in some aspects of the technology, each layer (307a, 307b, . . . 307z) may be configured to generate its respective output based directly on input x (302). Likewise, in some aspects of the technology, layers 2 through z (307b-307z) of the full model may be configured to generate their respective outputs based on input x (302) and the output of one or more prior layers of the full model. Further, in some aspects of the technology, the final prediction 320 of the full model may be based directly or indirectly on the output of layer z (307z) of the full model, or may be based on any suitable combination of outputs from two or more layers of the full model. For example, in some aspects of the technology, final prediction 320 may be a weighted linear combination of the outputs of every synthesized specialist model of every layer (307a-307z) of the full model.

FIG. 3C also shows an exemplary full model that employs a sparsifying function (e.g., 310a) to generate a sparse embedding vector (e.g., 312a) in each of the layers (307a, 307b, . . . 307z), as described above with respect to FIG. 3B. However, in the example of FIG. 3C, the initial embedding vector (e.g., 308a) used in each layer is generated by an embedding function 305 rather than a lightweight model 304. Embedding function 305 may be any suitable heuristic or learned function configured to generate an initial embedding vector (e.g., 308a) for each of the layers (307a, 307b, . . . 307z). As above, in some aspects of the technology, the initial embedding vector generated by the embedding function 305 may be different for every layer of the full model. Likewise, in some aspects, the same initial embedding vector may be used for every layer of the full model. Further, in some aspects, some layers of the full model may use the same initial embedding vector, while other layers of the full model may use different embedding vectors.

Although the examples of FIGS. 3A-3C each assume that the full set of basis models (e.g., 314a) for a given layer will be combined according to the combination coefficients of an embedding vector (e.g., 308a) or a sparse embedding vector (312a) in order to create a synthesized specialist model (e.g., 318a, 319a), and that the synthesized specialist model will then be used to generate an output based on input x (302), any suitable order of operations may be used. Thus, in some aspects of the technology, each of the basis models in a given layer (e.g., 314a) may generate an output based on input x (302), and those outputs may then be combined according to the combination coefficients of an embedding vector (e.g., 308a) or a sparse embedding vector (312a) in order to generate an output for that given layer.

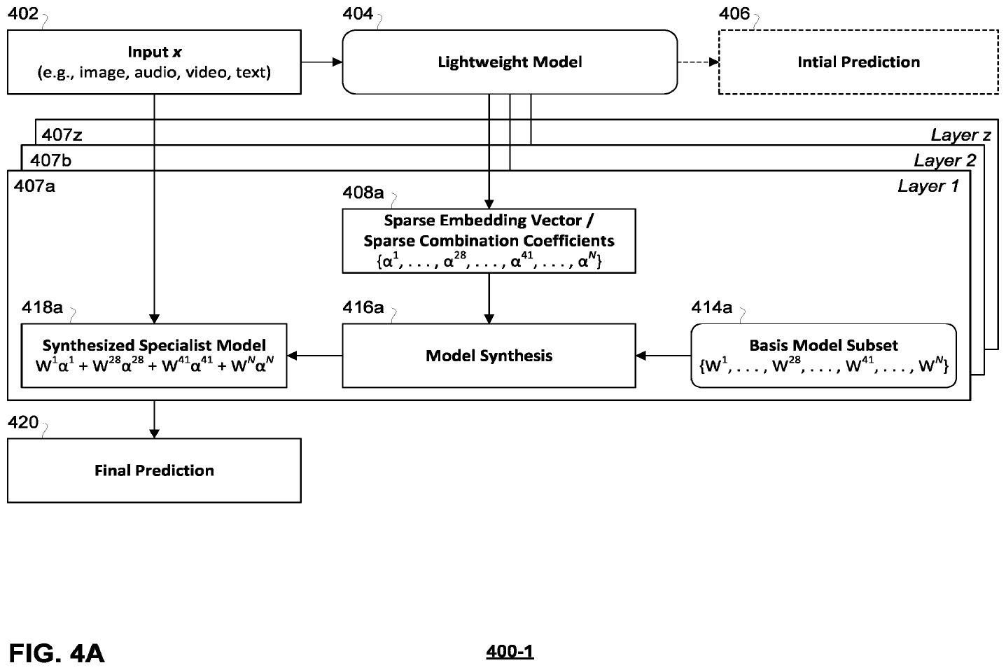

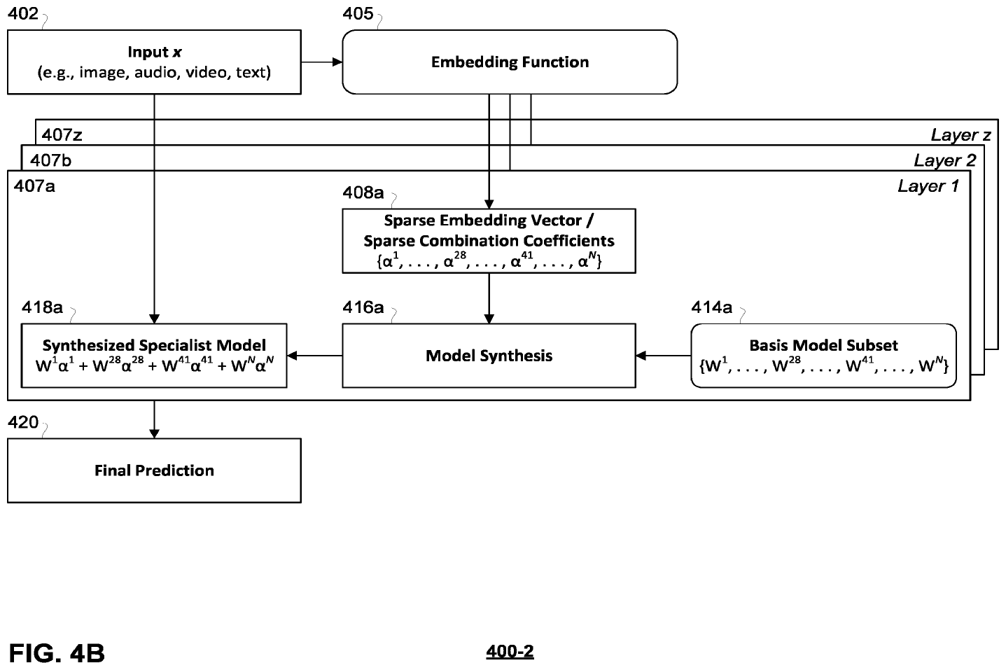

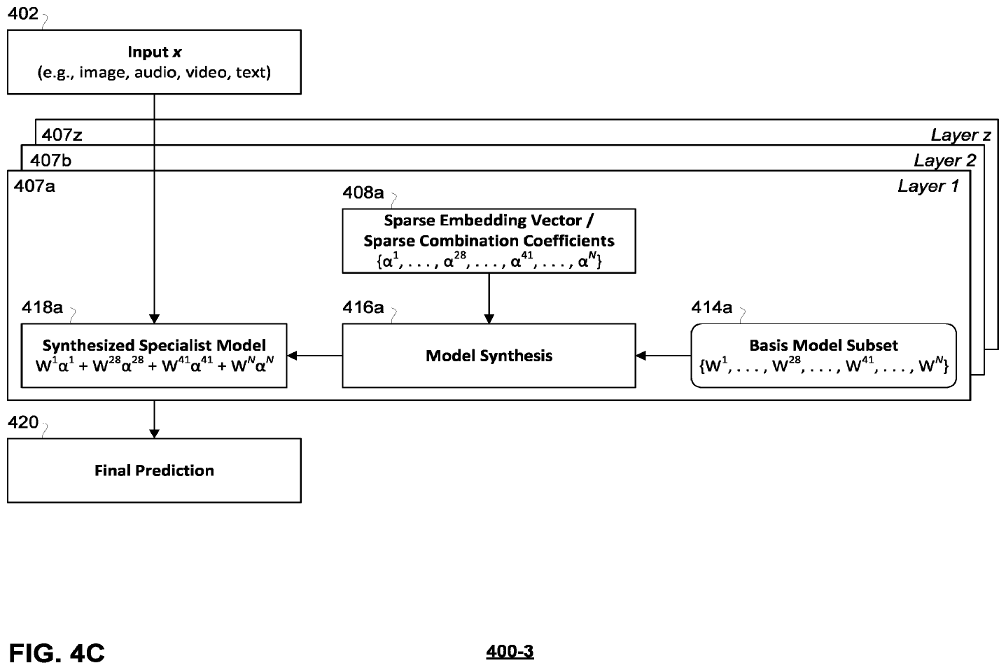

FIGS. 4A-4C are flow diagrams 400-1, 400-2, and 400-3 illustrating how exemplary partitioned models configured to use a model-synthesis approach may process an input to generate a final prediction, in accordance with aspects of the disclosure.

FIG. 4A shows one example of how an input x (402) may be processed using an exemplary partitioned model that includes a lightweight model 304. Here as well, input x (402) may be any type of input that the full model is configured to process, such as image data (e.g., a photograph, pixel data), audio data (e.g., music, a spoken utterance), video data (e.g., a movie with video with audio, a silent movie), text data (e.g., a sequence of characters, a sequence of words), etc. The flow depicted in FIG. 4A is generally consistent with the “BasisNet” approach described in International Patent Application No. PCT/US21/43655 and “BasisNet: Two-stage Model Synthesis for Efficient Inference” (M. Zhang et al., arXiv: 2105.03014v1), as well as that which is depicted and described above with respect to the example of FIG. 3A. However, in FIG. 4A, the lightweight model 404 is configured to generate a sparse embedding vector representing a sparse set of combination coefficients (e.g., 408a) that corresponds to a subset (e.g., basis model subset 414a) of the full set of basis models (e.g., the full set of basis models 314a of FIGS. 3A-3C). In some aspects of the technology, the lightweight model 304 may be incorporated into the partitioned model. Likewise, in some aspects, the lightweight model 304 may be stored on a different computing device than the partitioned model, and may be configured to transmit its outputs to the partitioned model. For example, in some aspects of the technology, the lightweight model 404 may be a part of a full model, and may be called by the partitioned model. Further, in some aspects, the lightweight model 404 may be distributed between a full model and the partitioned model. For example, in some aspects of the technology, the partitioned model may call a first portion of lightweight model 404 that is included in a full model (e.g., lightweight model 304 of FIG. 3A) to obtain an embedding vector (e.g., 308a of FIG. 3A), and a second portion of lightweight model 404 that is included in the partitioned model may be configured to process or filter that embedding vector to generate the sparse embedding vector (e.g., 408a) for each given layer of the partitioned model.

Moreover, in some aspects of the technology, the partitioned model may be configured to use lightweight model 404 intermittently in order to further reduce processing demands. For example, the partitioned model may be configured to use the lightweight model 404 to generate a sparse embedding vector (e.g., 408a) for each layer of the partitioned model, and then to use those generated sparse embedding vector for a predetermined number of inference steps (e.g., 100 inference steps, 1,000 inference steps). After the partitioned model has performed the predetermined number of inference steps, it may be configured to call the lightweight model 404 to generate an updated sparse embedding vector (e.g., 408a) for each layer of the partitioned model, which may then be used for the next predetermined number of inference steps.

Here as well, the lightweight model 404 is shown generating a sparse embedding vector representing a sparse set of combination coefficients (e.g., {α¹, . . . , α²⁸, . . . , α⁴¹, . . . , α^{N}}) for each of the partitioned model's layers 1 through z (407a, 407b, . . . 407z). In some aspects of the technology, the generated sparse embedding vector may be different for every layer of the partitioned model. In some aspects, the same generated sparse embedding vector may be used for every layer of the partitioned model. In some aspects, some layers of the partitioned model may use the same generated sparse embedding vector, while other layers of the partitioned model may use a different sparse embedding vector. In some aspects of the technology, the sets of combination coefficients for each of the partitioned model's layers 1 through z (407a, 407b, . . . 407z) may be included in separate embedding vectors for each layer. In some aspects of the technology, the sets of combination coefficients for each of the partitioned model's layers 1 through z (407a, 407b, . . . 407z) may be combined into a single embedding vector for the full model.

In each layer of the partitioned model, the sparse embedding vector (e.g., 408a) will be used to combine a basis model subset for that layer. Thus, in FIG. 4A, it has been assumed that the first layer (407a) of the partitioned model will use a basis model subset 414a of {W¹, . . . , W²⁸, . . . , W⁴¹, . . . , W^{N}}, which is a subset of the full set of basis models 314a shown in the first layer (307a) of FIG. 3A. This basis model subset 414a is then used together with the sparse embedding vector 408a to generate the synthesized specialist model 418a for layer 1 (407a) of the partitioned model. Here as well, this process is shown as taking place in the model synthesis block 416a using linear combination, resulting in a synthesized specialist model 418a of W¹α¹+W²⁸α²⁸+W⁴¹α⁴¹+W^{N}α^{N}. However, any suitable type of combination may be employed by model synthesis block 416a. In addition, the type of combination used by the model synthesis block of each layer may be unique to that layer, or may be the same as that which is used in one or more of the other layers of the partitioned model. Likewise, the basis model subset (e.g., 414a) used in each layer may be unique to that layer, or may be the same as that which is used in one or more of the other layers of the partitioned model.

In the example of FIG. 4A (and in the examples of FIGS. 4B and 4C, described below), it is assumed that all basis models in each of layers 1 through z will share the same architecture, and will differ only as to one or more of their weight parameters. However, in some aspects of the technology, each given layer of the partitioned model may have a basis model subset (e.g., 414a) in which each individual basis model has same architecture and differs only in its respective weights, but the architecture of the basis models in one or more layers may be different than the architecture of the basis models in another layer of the partitioned model. Further, in some aspects, some or all of the basis models used in a given layer of the partitioned model may have different architectures than other basis models in that same layer. Thus, in some aspects of the technology, one or more layers of the partitioned model may have a full set of basis models in which every basis model has a unique architecture.

Here as well, once the synthesized specialist model has been generated for a given layer, it will be used to create an output based directly or indirectly on the input x (402). In that regard, in the example of FIG. 4A, it is assumed that the synthesized specialist model 418a of layer 1 (407a) will generate a first output based directly on input x (402), and that the first output will be passed to the next layer, where the synthesized specialist model 418b (not shown) of layer 2 (407b) will then generate a second output based on the first output. This process may then continue until layer z (407z), where the output generated by synthesized specialist model 418z (not shown) may be used as the final prediction 420. However, in some aspects of the technology, each layer (407a, 407b, . . . 407z) may be configured to generate its respective output based directly on input x (402). Likewise, in some aspects of the technology, layers 2 through z (407b-407z) of the partitioned model may be configured to generate their respective outputs based on input x (402) and the output of one or more prior layers of the partitioned model. Further, in some aspects of the technology, the final prediction 420 of the partitioned model may be based directly or indirectly on the output of layer z (407z) of the partitioned model, or may be based on any suitable combination of outputs from two or more layers of the partitioned model. For example, in some aspects of the technology, final prediction 420 may be a weighted linear combination of the outputs of every synthesized specialist model of every layer (407a-407z) of the partitioned model.

Here as well, final prediction 420 may be in any suitable form. Thus, where the input x (402) comprises image data (e.g., pixel data), the final prediction 420 may comprise classification data indicative of a particular class or group of classes to which the image belongs within a plurality of classes. Further, in some aspects, the classification data may comprise a distribution over the plurality of classes. For example, each class of the plurality of classes may represent a respective object type, and the final prediction 420 may comprise scores for each class indicating whether any object in that class is predicted to be present in the image. Likewise, where the input x (402) comprises audio data of a spoken utterance, the final prediction 420 may comprise a transcription of the spoken utterance. Further, where the input x (402) comprises a sequence of text, the final prediction 420 may be another sequence of text. For example, the input x (402) may be the text of a user's request to an automated assistant, and the final prediction 420 may be a generated text response to the user's request. Likewise, the input x (402) may be text in a first language, and the final prediction 420 may be a translation of the input text into a second language.

As shown in FIG. 4A, the lightweight model 404 may also optionally be configured to generate an initial prediction 406. Here as well, this initial prediction 406 may further include a confidence value, and the partitioned model may be configured to forego processing input x through layers 1 through z (407a-407z) where the lightweight model 404 produces an initial prediction 406 based on input x that has a confidence value that exceeds a predetermined threshold (e.g., 80%, 85%, 90%, 95%, 99%, etc.).

FIG. 4B shows an exemplary partitioned model similar to that of FIG. 4A, but in which the sparse embedding vector (e.g., 408a) used in each layer is generated by an embedding function 405 rather than a lightweight model 404. Here as well, embedding function 405 may be any suitable heuristic or learned function configured to generate a sparse embedding vector (e.g., 408a) for each of the layers (407a, 407b, . . . 407z). As above, in some aspects of the technology, the sparse embedding vector generated by the embedding function 405 may be different for every layer of the partitioned model. Likewise, in some aspects, the same sparse embedding vector may be used for every layer of the partitioned model. Further, in some aspects, some layers of the partitioned model may use the same sparse embedding vector, while other layers of the partitioned model may use different sparse embedding vectors.

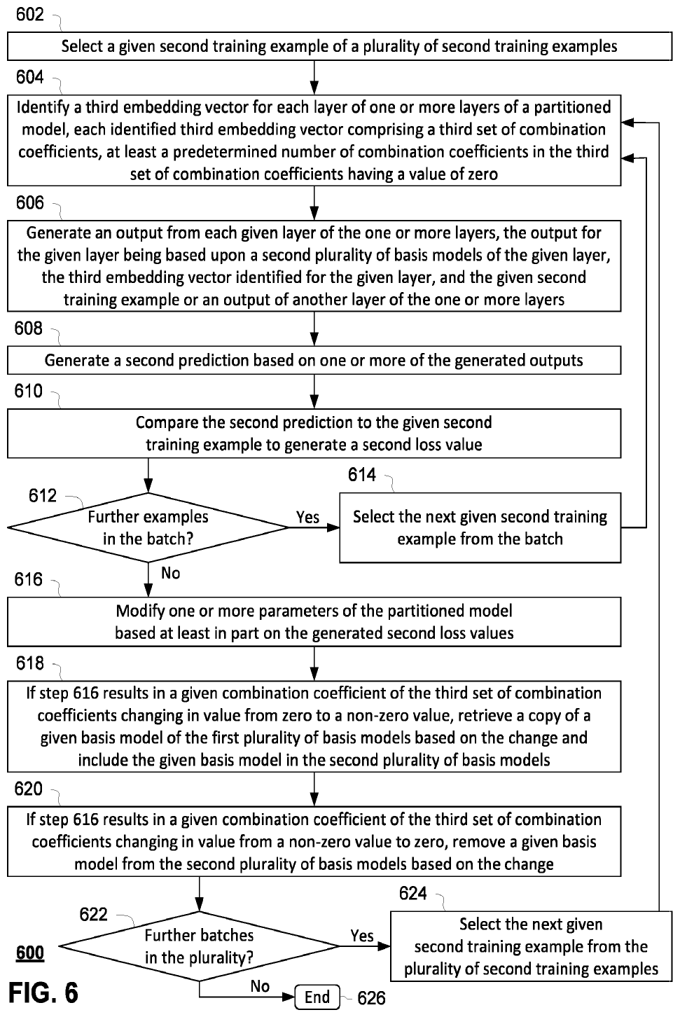

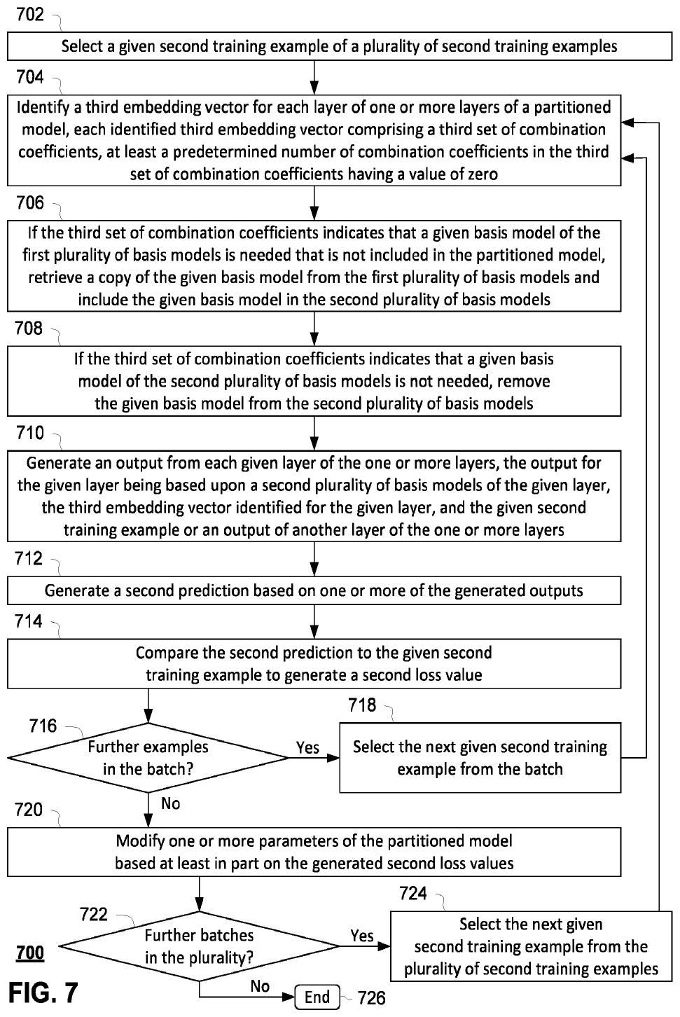

FIG. 4C shows an exemplary partitioned model similar to that of FIGS. 4A and 4B, but in which a preselected sparse embedding vector (e.g., 408a) is used for each layer. For example, a full model (e.g., the full model of FIG. 3B or 3C) may be trained using a set of training data representative of that which the partitioned model is expected to encounter, and may generate an optimized sparse embedding vector for each layer of the full model. That optimized sparse embedding vector for each layer of the full model may then be used as the preselected sparse embedding vector (e.g., 408a) for each layer (407a-407z) of a partitioned model. As described further below with respect to FIGS. 6 and 7, in some aspects of the technology, the partitioned model may also continue to be trained periodically as it is used (e.g., using data actually encountered by the partitioned model, and implicit or explicit feedback from the user), which may result in modification of the sparse embedding vector. In some cases, these modifications may include one or more combination coefficients changing from a zero value to a non-zero value, or vice versa, in which case basis models may be added or removed from the basis model subset (e.g., 414a). In that regard, although a given basis model may be removed from a given basis model subset (e.g., 414a), in some aspects of the technology, the processing system may be configured to retain a cached copy of the given basis model for some period of time (e.g., until a given training session is concluded) to avoid having to re-acquire it from the full model if further training results in the given basis model being needed again.

Here as well, although the examples of FIGS. 4A-4C each assume that the basis model subset (e.g., 414a) for a given layer will be combined according to the combination coefficients of a sparse embedding vector (408a) in order to create a synthesized specialist model (e.g., 418a), and that the synthesized specialist model will then be used to generate an output based on input x (402), any suitable order of operations may be used. Thus, in some aspects of the technology, each of the basis models in a given layer (e.g., 414a) may generate an output based on input x (402), and those outputs may then be combined according to the combination coefficients of a sparse embedding vector (408a) in order to generate an output for that given layer.

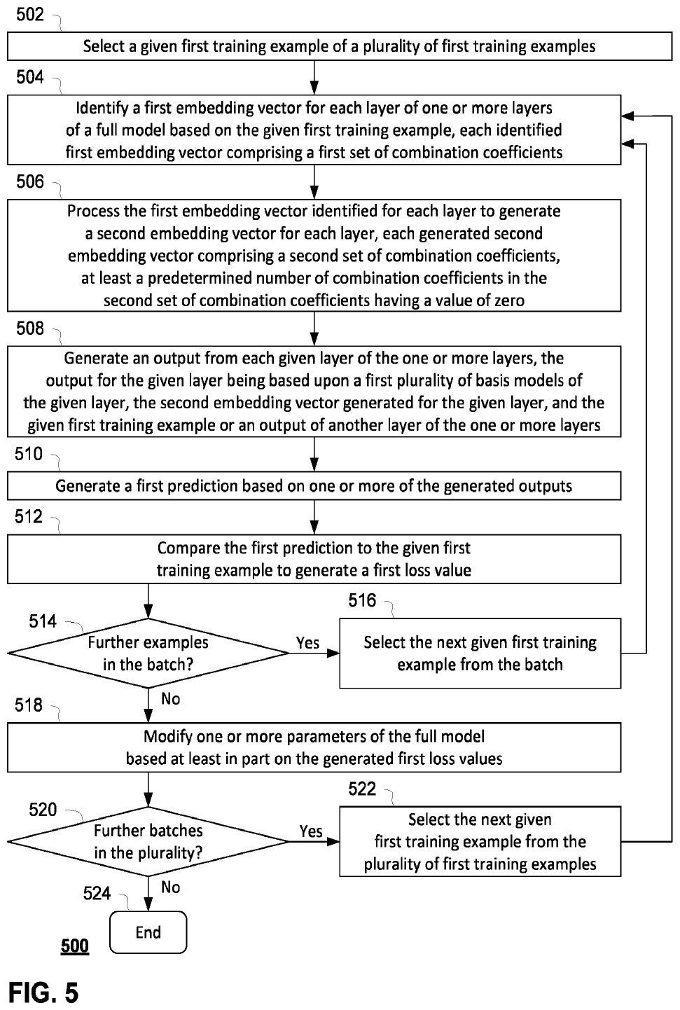

FIG. 5 sets forth an exemplary method 500 for training a full model (e.g., the full models of FIG. 3B or 3C) to generate predictions based on a sparse set of combination coefficients, in accordance with aspects of the disclosure.

In step 502, the processing system (e.g., processing system 102 of FIG. 1 or 2) selects a given first training example of a plurality of first training examples. This plurality of first training examples may be any suitable type of training example, from any suitable source. For example, the plurality of first training examples may include examples from existing databases of training data, or any other human-generated or synthetically generated training examples. In addition, in some aspects of the technology, the plurality of first training examples may include data specific to a given device or application. For example, where the full model is expected to be partitioned and used on a given device (e.g., a mobile phone, tablet, personal computer, etc.) as an automated assistant, the plurality of first training examples may include questions about the given device and/or one or more applications (e.g., a web browser, email utility, etc.) that are expected to be resident on the given device. In some aspects, these questions may be harvested from logs of actual questions asked by a user of the given device or application, and logs of actual responses provided thereto. In such a case, the target response for each such training example may be gleaned from feedback from the user. For example, where the model is an automated assistant, the logs may reveal express user feedback, e.g., the user may be asked to indicate if the automated assistant's response was helpful. Likewise, where the model is a language model configured to automatically generate suggested responses to text messages or emails, the user may provide implicit feedback by either using the automatically generated response without modification, or through their edits to the automatically generated response.

In step 504, the processing system identifies a first embedding vector (e.g., embedding vector 308a of FIGS. 3B and 3C) for each layer of one or more layers of a full model (e.g., layers 1-z (307a-307z) of FIGS. 3B and 3C) based on the given first training example. Each of these identified first embedding vectors comprises a first set of combination coefficients (e.g., as shown in embedding vector 308a of FIGS. 3B and 3C). The first embedding vector for each layer of the one or more layers of the full model may be identified in any suitable way. For example, in some aspects of the technology, the full model may include a lightweight model (e.g., lightweight model 304 of FIG. 3B) configured to generate each first embedding vector based on the given first training example. Likewise, in some aspects of the technology, the full model may include a heuristic or learned embedding function (e.g. embedding function 305 of FIG. 3C) configured to generate each first embedding vector based on the given first training example. In some aspects of the technology, the first embedding vector for each layer of the one or more layers of the full model may be identified from within a single vector or matrix which includes a first set of combination coefficients for each layer of the one or more layers of the full model.

In step 506, the processing system processes the first embedding vector identified for each layer to generate a second embedding vector for each layer, each generated second embedding vector comprising a second set of combination coefficients, at least a predetermined number of combination coefficients in the second set of combination coefficients having a value of zero. Here as well, in some aspects of the technology, the second embedding vector for each layer of the one or more layers of the full model may be generated in the form of a single vector or matrix which includes a second set of combination coefficients for each layer of the one or more layers of the full model. The processing system may ensure that at least a predetermined number of the combination coefficients in the second set of combination coefficients have a value of zero in any suitable way. For example, the processing system may use any of the different options mentioned above for sparsifying function 310a of FIGS. 3B and 3C. Thus, the processing system may process the first embedding vector using a modified softmax activation function configured to output probabilities that are k sparse or no greater than k sparse (e.g., Sparsemax), a function configured to generate the second embedding vector from the k largest elements or coefficients of the first embedding vector, a function configured to generate a second embedding vector from a random selection of k elements of the first embedding vector, etc. Here as well, the processing system may use a different type of sparsifying function in each layer of the full model, or may use the same sparsifying function in one or more of the layers.

In step 508, the full model generates an output from each given layer of the one or more layers, the output for the given layer being based upon a first plurality of basis models of the given layer, the second embedding vector generated for the given layer, and the given first training example or an output of another layer of the one or more layers. Here as well, the full model may generate an output in each layer using any of the options set forth above with respect to the synthesized specialist models 319a of FIGS. 3B and 3C, or in any other suitable way. Thus, the second embedding vector may be combined with the first plurality of basis models using linear combination or any other suitable type of combination to generate a synthesized specialist model for each given layer, and the output from each given layer may then be generated by the synthesized specialist model for the given layer. Moreover, where the second embedding vector is combined with the first plurality of basis models, the type of combination used in each layer may be unique to that layer, or may be the same as that which is used in one or more of the other layers of the full model. Likewise, the first plurality of basis models used in each layer may be unique to that layer, or may be the same as that which is used in one or more of the other layers of the full model.

Further, the output generated in each given layer may be based directly or indirectly on the given first training example. Thus, in some aspects of the technology, each given layer may be configured to generate its respective output based directly on the given first training example. In addition, in some aspects of the technology, the output generated in the first layer of the full model may be based directly on the given first training example, and that output may then be passed to the next given layer, which will generate a second output based on the first output. This process may then continue until the final layer, such that the outputs of all but the first layer are based indirectly on the first training example. Likewise, in some aspects of the technology, the output generated in the first layer of the full model may be based directly on the given first training example, and all other layers of the full model may be configured to generate their respective outputs based on both the given first training example and the output of one or more prior layers of the full model.

In step 510, the full model generates a first prediction based on one or more of the generated outputs. The full model may be configured to base this first prediction on any or all of the outputs generated in step 508. Thus, as described above with respect to final prediction 320 of FIGS. 3B and 3C, the first prediction may be the output of the final layer of the full model, a prediction based on the output of the final layer of the full model, a prediction based on any suitable combination of outputs from two or more layers of the full model (e.g., a weighted linear combination of the outputs of every layer of the full model), etc.

In step 512, the processing system compares the first prediction (of step 510) to the given first training example to generate a first loss value. This first loss value may be generated in any suitable way, using any suitable loss function. For example, in some aspects of the technology, where the full model is a language model and the first prediction is in the form of generated text, the processing system may be configured to compare the full model's first prediction to the ground truth of the given first training example using a “hard distillation” method that assesses how similar the generated text is to the text of the ground truth. Likewise, in some aspects, the processing system may be configured to compare the full model's first prediction to the ground truth of the given first training example using a connectionist temporal classification loss (“CTC loss”) or a cross-entropy loss.

In step 514, the processing system determines if there are further training examples in the batch. In that regard, the plurality of first training examples may be broken into multiple batches, or kept whole, in which case there will be one single “batch” containing every first training example of the plurality of first training examples. In either case, as shown by the “yes” arrow, if the processing system determines that there are further training examples in the batch, it will proceed to step 516. In step 516, the processing system will select the next given first training example from the batch, and then repeat steps 504-514 for that newly selected training example. This process will then be repeated for each next given first training example of the batch until the processing system determines, at step 514, that there are no further training examples in the batch, and thus proceeds to step 518 (as shown by the “no” arrow).

As shown in step 518, after a “first loss value” has been generated (in step 512) for every given first training example in the batch, the processing system modifies one or more parameters of the full model based at least in part on the generated first loss values. The processing system may be configured to modify the one or more parameters based on these generated first loss values in any suitable way and at any suitable interval. For example, an optimization routine, such as stochastic gradient descent, may be applied to the generated first loss values to determine parameter modifications. In some aspects of the technology, each “batch” may include a single training example such that the processing system will conduct a back-propagation step in which it modifies the one or more parameters of the full model every time a first loss value is generated. Likewise, where each “batch” includes two or more training examples, the processing system may be configured to combine the generated first loss values into an aggregate loss value (e.g., by summing or averaging the multiple first loss values), and modify the one or more parameters of the full model based on that aggregate loss value.

In step 520, the processing system determines if there are further batches in the plurality of first training examples. Where the plurality of first training examples has not been broken up, and there is thus one single “batch” containing every first training example in the plurality of first training examples, the determination in step 520 will automatically be “no,” and method 500 will then end as shown in step 524. However, where the plurality of first training examples has been broken into two or more batches, the processing system will follow the “yes” arrow to step 522 to select the next given first training example from the training set. This will then start another set of passes through steps 504-514 for each training example in the next batch and another modification of one or more parameters of the full model in step 518. This process will continue until there are no further batches remaining, at which point the processing system will follow the “no” arrow to step 524.

Although method 500 is shown as ending in step 524 once all first training examples of the plurality of first training examples have been used to tune the parameters of the full model, it will be understood that method 500 may be repeated any suitable number of times using the same plurality of first training examples until each of its first predictions are sufficiently close to the ground truth of each respective first training example. In that regard, in some aspects of the technology, the processing system may be configured to repeat method 500 for the plurality of first training examples some predetermined number of times. Further, in some aspects, the processing system may be configured to aggregate all of the first loss values generated during a given pass through method 500, and determine whether to repeat method 500 for the plurality of first training examples based on that aggregate loss value. For example, in some aspects of the technology, the processing system may be configured to repeat method 500 for the plurality of first training examples if the aggregate loss value for the most recent pass through method 500 was greater than some predetermined threshold. Likewise, in some aspects, the processing system may be configured to use gradient descent, and to thus repeat method 500 for the plurality of first training examples until the aggregate loss value on a given pass through method 500 is equal to or greater than the aggregate loss value from the pass before it.

FIG. 6 sets forth an exemplary method 600 for training a partitioned model (e.g., the partitioned models of FIG. 4A, 4B, or 4C) to generate predictions based on a sparse set of combination coefficients and to update its set of basis models, in accordance with aspects of the disclosure. Method 600 may be performed by itself, or following performance of method 500 of FIG. 5. Thus, in some aspects of the technology, method 500 of FIG. 5 may be used to train a full model to generate predictions based on sparse second embedding vectors, and then a subset of the basis models of that trained full model may be used to generate a partitioned model which may be further trained using method 600 of FIG. 6. Likewise, in some aspects of the technology, a partitioned model may be trained from scratch using method 600 of FIG. 6. Further, as explained below, in some aspects of the technology, method 600 may be used by two or more partitioned models to generate second loss values (or associated parameter modifications) that may be shared with a separate full model, such that the full model may be trained in a federated manner.

In step 602, the processing system (e.g., processing system 102 of FIG. 1 or 2) selects a given second training example of a plurality of second training examples. The terminology “second” is being used here only to avoid confusion with the “first” training examples described above with respect to method 500 of FIG. 5. However, the training examples (as well as the embedding vectors, set of combination coefficients, predictions, and loss values) referred to in method 600 may be referred to with any other suitable term or ordinal (including “first,” where it would not risk confusion).

The plurality of second training examples may be any suitable type of training example, from any suitable source. For example, the plurality of second training examples may include examples from existing databases of training data, or any other human-generated or synthetically generated training examples. In addition, in some aspects of the technology, the plurality of second training examples may include data specific to a given device or application. For example, where the partitioned model is to be used on a given device (e.g., a mobile phone, tablet, personal computer, etc.) as an automated assistant, the plurality of second training examples may include questions about the given device and/or one or more applications (e.g., a web browser, email utility, etc.) that are expected to be resident on the given device. In some aspects, these questions may be harvested from logs of actual questions asked by a user of the given device or application, and logs of actual responses provided thereto. In such a case, the target response for each such training example may be gleaned from feedback from the user. For example, where the model is an automated assistant, the logs may reveal express user feedback, e.g., the user may be asked to indicate if the automated assistant's response was helpful. Likewise, where the model is a language model configured to automatically generate suggested responses to text messages or emails, the user may provide implicit feedback by either using the automatically generated response without modification, or through their edits to the automatically generated response.

In step 604, the processing system identifies a third embedding vector (e.g., sparse embedding vector 408a of FIG. 4A, 4B, or 4C) for each layer of one or more layers of a partitioned model (e.g., layers 1-z (407a-407z) of FIG. 4A, 4B, or 4C). Each of these identified third embedding vectors comprises a third set of combination coefficients (e.g., as shown in sparse embedding vector 408a of FIG. 4A, 4B, or 4C), with at least a predetermined number of combination coefficients in the third set of combination coefficients having a value of zero. In some aspects of the technology, the third embedding vector for each layer of the one or more layers of the partitioned model may be identified from within a single vector or matrix which includes a third set of combination coefficients for each layer of the one or more layers of the partitioned model. Here as well, the terminology “third” is being used only to avoid confusion with the “first” embedding vector and “first” set of combination coefficients described above with respect to method 500 of FIG. 5, but any other suitable term or ordinal may be used (including “first,” where it would not risk confusion).

The third embedding vector for each layer of the one or more layers of the partitioned model may be identified in any suitable way. For example, in some aspects of the technology, the partitioned model may include a lightweight model (e.g., lightweight model 404 of FIG. 4A) configured to generate each third embedding vector based on the given second training example. Likewise, in some aspects of the technology, the partitioned model may include a heuristic or learned embedding function (e.g. embedding function 405 of FIG. 4B) configured to generate each third embedding vector based on the given second training example. Further, in some aspects of the technology, a preselected third embedding vector may be used for each layer (as described above), and the partitioned model may thus identify the preselected third embedding vector for each layer from a table, matrix, or any other suitable data structure which correlates a preselected third embedding vector with each layer. In such a case, the partitioned model may use these preselected third embedding vectors for every given second training example until one or more of the third embedding vectors are updated (e.g., as a result of step 616, described further below).

In step 606, the partitioned model generates an output from each given layer of the one or more layers of the partitioned model, the output for the given layer being based upon a second plurality of basis models of the given layer, the third embedding vector identified for the given layer, and the given second training example or an output of another layer of the one or more layers of the partitioned model.

Here as well, the partitioned model may generate an output in each layer using any of the options set forth above with respect to the synthesized specialist models 418a of FIGS. 4A, 4B, and 4C, or in any other suitable way. Thus, the third embedding vector may be combined with the second plurality of basis models using linear combination or any other suitable type of combination to generate a synthesized specialist model for each given layer, and the output from each given layer may then be generated by the synthesized specialist model for the given layer. Moreover, where the third embedding vector is combined with the second plurality of basis models, the type of combination used in each layer may be unique to that layer, or may be the same as that which is used in one or more of the other layers of the partitioned model. Likewise, the second plurality of basis models used in each layer may be unique to that layer, or may be the same as that which is used in one or more of the other layers of the partitioned model.

In addition, in some aspects of the technology, the partitioned model may reverse the order of operations (as also described above), and first generate individual outputs using each basis model of the second plurality of basis models. In such a case, the individual outputs may be generated by each basis model in a given layer based on the given second training example or an output of another layer of the one or more layers of the partitioned model, and then those individual outputs may be combined (e.g., using a linear combination) according to the third embedding vector for the given layer to generate an output for the given layer.

Further, the output generated in each given layer may be based directly or indirectly on the given second training example. Thus, in some aspects of the technology, each given layer may be configured to generate its respective output based directly on the given second training example. In addition, in some aspects of the technology, the output generated in the first layer of the partitioned model may be based directly on the given second training example, and that output may then be passed to the next given layer, which will generate a second output based on the first output. This process may then continue until the final layer, such that the outputs of all but the first layer are based indirectly on the second training example. Likewise, in some aspects of the technology, the output generated in the first layer of the partitioned model may be based directly on the given second training example, and all other layers of the partitioned model may be configured to generate their respective outputs based on both the given second training example and the output of one or more prior layers of the partitioned model.

In step 608, the partitioned model generates a second prediction based on one or more of the generated outputs. Here as well, the terminology “second” is being used only to avoid confusion with the “first” prediction described above with respect to method 500 of FIG. 5, but any other suitable term or ordinal may be used (including “first,” where it would not risk confusion). The partitioned model may be configured to base this second prediction on any or all of the outputs generated in step 606. Thus, as described above with respect to final prediction 420 of FIGS. 4A, 4B, and 4C, the second prediction may be the output of the final layer of the partitioned model, a prediction based on the output of the final layer of the partitioned model, a prediction based on any suitable combination of outputs from two or more layers of the partitioned model (e.g., a weighted linear combination of the outputs of every layer of the partitioned model), etc.

In step 610, the processing system compares the second prediction (of step 608) to the given second training example to generate a second loss value. Here as well, the terminology “second” is being used only to avoid confusion with the “first” prediction and “first” loss value described above with respect to method 500 of FIG. 5, but any other suitable term or ordinal may be used (including “first,” where it would not risk confusion). This second loss value may be generated in any suitable way, using any suitable loss function. For example, in some aspects of the technology, where the partitioned model is a language model and the second prediction is in the form of generated text, the processing system may be configured to compare the partitioned model's second prediction to the ground truth of the given second training example using a “hard distillation” method that assesses how similar the generated text is to the text of the ground truth. Likewise, in some aspects, the processing system may be configured to compare the partitioned model's second prediction to the ground truth of the given second training example using a CTC loss or a cross-entropy loss.

In step 612, the processing system determines if there are further training examples in the batch. Here as well, the plurality of second training examples may be broken into multiple batches, or kept whole, in which case there will be one single “batch” containing every second training example of the plurality of first training examples. In either case, as shown by the “yes” arrow, if the processing system determines that there are further training examples in the batch, it will proceed to step 614. In step 614, the processing system will select the next given second training example from the batch, and then repeat steps 604-612 for that newly selected training example. This process will then be repeated for each next given second training example of the batch until the processing system determines, at step 612, that there are no further training examples in the batch, and thus proceeds to step 616 (as shown by the “no” arrow).

As shown in step 616, after a “second loss value” has been generated (in step 610) for every given second training example in the batch, the processing system modifies one or more parameters of the partitioned model based at least in part on the generated second loss values. Here as well, the processing system may be configured to modify the one or more parameters based on these generated second loss values in any suitable way and at any suitable interval. For example, an optimization routine, such as stochastic gradient descent, may be applied to the generated second loss values to determine parameter modifications. In some aspects of the technology, each “batch” may include a single training example such that the processing system will conduct a back-propagation step in which it modifies the one or more parameters of the full model every time a second loss value is generated. Likewise, where each “batch” includes two or more training examples, the processing system may be configured to combine the generated second loss values into an aggregate loss value (e.g., by summing or averaging the multiple second loss values), and modify the one or more parameters of the partitioned model based on that aggregate loss value.

In addition, although step 616 describes modifying one or more parameters of the partitioned model, in some aspects of the technology, the processing system may be further configured to make the same (or similar changes) to the parameters of a separate full model based on the generated second loss values. For example, in some aspects of the technology, method 600 may be run on two or more partitioned models, each having a different subset of basis models. In such a case, each partitioned model may follow method 600 to generate second loss values, and to modify its respective parameters based thereon. In addition, each partitioned model may be configured to share its second loss values, its modified parameters, and/or the training gradients used to modify its parameters, with a separate full model, so that the same or similar changes can be made to the parameters of the full model. In this way, it is possible to split the full set of basis models of the full model into multiple partitioned models, and train the full model in a federated manner based on what is learned by each of the partitioned models.

In step 618, the processing system determines whether the modification of one or more parameters of the partitioned model (in step 616) results in any given combination coefficient of the third set of combination coefficients changing in value from zero to a non-zero value. If so, the processing system will then retrieve (e.g., from a computing device hosting the full model, a remote storage system, etc.) a copy of a given basis model of the first plurality of basis models based on the change and include the given basis model in the second plurality of basis models. Likewise, in step 620, the processing system determines whether the modification of one or more parameters of the partitioned model (in step 616) results in any given combination coefficient of the third set of combination coefficients changing in value from a non-zero value to zero. If so, the processing system will then remove a given basis model from the second plurality of basis models. Thus, if the partitioned model encounters a batch of training examples that causes the processing system to determine (through parameter modification step 616) that a different collection of basis models would allow the partitioned model to make better second predictions, the processing system will add and subtract basis models from the second plurality of basis models according to steps 618 and 620. Here as well, although a given basis model may be removed from the second plurality of basis models, in some aspects of the technology, the processing system may be configured to retain a cached copy of the given basis model for some period of time (e.g., until method 600 is concluded) to avoid having to re-acquire it if further training results in the given basis model being needed again.

In step 622, the processing system determines if there are further batches in the plurality of second training examples. Here as well, where the plurality of second training examples has not been broken up, and there is thus one single “batch” containing every second training example in the plurality of second training examples, the determination in step 622 will automatically be “no,” and method 600 will then end as shown in step 626. However, where the plurality of second training examples has been broken into two or more batches, the processing system will follow the “yes” arrow to step 624 to select the next given second training example from the training set. This will then start another set of passes through steps 604-614 for each training example in the next batch and another modification of one or more parameters of the partitioned model in step 616. This process will continue until there are no further batches remaining, at which point the processing system will follow the “no” arrow to step 626.

Here as well, although method 600 is shown as ending in step 626 once all second training examples of the plurality of second training examples have been used to tune the parameters of the partitioned model, it will be understood that method 600 may be repeated any suitable number of times using the same plurality of second training examples until each of its second predictions are sufficiently close to the ground truth of each respective second training example. In that regard, in some aspects of the technology, the processing system may be configured to repeat method 600 for the plurality of second training examples some predetermined number of times. Further, in some aspects, the processing system may be configured to aggregate all of the second loss values generated during a given pass through method 600, and determine whether to repeat method 600 for the plurality of second training examples based on that aggregate loss value. For example, in some aspects of the technology, the processing system may be configured to repeat method 600 for the plurality of second training examples if the aggregate loss value for the most recent pass through method 600 was greater than some predetermined threshold. Likewise, in some aspects, the processing system may be configured to use gradient descent, and to thus repeat method 600 for the plurality of second training examples until the aggregate loss value on a given pass through method 600 is equal to or greater than the aggregate loss value from the pass before it.

FIG. 7 sets forth another exemplary method 700 for training a partitioned model (e.g., the partitioned models of FIG. 4A, 4B, or 4C) to generate predictions based on a sparse set of combination coefficients and to update its set of basis models, in accordance with aspects of the disclosure. Method 700 is similar to method 600 of FIG. 6, but may additionally be applied in cases where the modification of one or more parameters of the partitioned model does not directly change the elements of the third embedding vector. For example, in some aspects of the technology, the modification of one or more parameters of the partitioned model may result in changes to a lightweight model (e.g., lightweight model 404 of FIG. 4A) or a learned embedding (e.g., embedding function 405 of FIG. 4B), which may in turn result in the lightweight model or learned embedding subsequently producing third embedding vectors that indicate a need for one or more changes to the second plurality of basis models. Likewise, in some aspects of the technology, the partitioned model may receive periodic updates from other computing devices or models (e.g., a separate computing device or a separate model may periodically transmit new third embedding vectors to the partitioned model), which may indicate a need for one or more changes to the second plurality of basis models.

As with method 600, method 700 of FIG. 7 may be performed by itself, or following performance of method 500 of FIG. 5. Thus, in some aspects of the technology, method 500 of FIG. 5 may be used to train a full model to generate predictions based on sparse second embedding vectors, and then a subset of the basis models of that trained full model may be used to generate a partitioned model which may be further trained using method 700 of FIG. 7. Likewise, in some aspects of the technology, method 500 of FIG. 5 may be used to train a full model and an associated lightweight model or learned embedding function to generate sparse second embedding vectors and predictions based thereon, and then the lightweight model or learned embedding function and a subset of the basis models of that trained full model may be used to generate a partitioned model which may be further trained using method 700 of FIG. 7. In addition, in some aspects of the technology, a partitioned model may be trained from scratch using method 700 of FIG. 7. Further, as explained below, in some aspects of the technology, method 700 may be used by two or more partitioned models to generate second loss values (or associated parameter modifications) that may be shared with a separate full model, such that the full model may be trained in a federated manner.

In step 702, the processing system (e.g., processing system 102 of FIG. 1 or 2) selects a given second training example of a plurality of second training examples. Step 702 is identical to step 602 of FIG. 6, and thus may be understood as described above with respect to FIG. 6.

In step 704, the processing system identifies a third embedding vector (e.g., sparse embedding vector 408a of FIG. 4A, 4B, or 4C) for each layer of one or more layers of a partitioned model (e.g., layers 1-z (407a-407z) of FIG. 4A, 4B, or 4C). Each of these identified third embedding vectors comprises a third set of combination coefficients (e.g., as shown in sparse embedding vector 408a of FIG. 4A, 4B, or 4C), with at least a predetermined number of combination coefficients in the third set of combination coefficients having a value of zero. Step 704 is identical to step 604 of FIG. 6, and thus may be understood as described above with respect to FIG. 6.

In that regard, the third embedding vector for each layer of the one or more layers of the partitioned model may be identified in any suitable way. For example, in some aspects of the technology, the partitioned model may include a lightweight model (e.g., lightweight model 404 of FIG. 4A) configured to generate each third embedding vector based on the given second training example. Likewise, in some aspects of the technology, the partitioned model may include a heuristic or learned embedding function (e.g. embedding function 405 of FIG. 4B) configured to generate each third embedding vector based on the given second training example. Further, in some aspects of the technology, a preselected third embedding vector may be used for each layer (as described above), and the partitioned model may thus identify the preselected third embedding vector for each layer from a table, matrix, or any other suitable data structure which correlates a preselected third embedding vector with each layer. In such a case, the partitioned model may use these preselected third embedding vectors for every given second training example until one or more of the third embedding vectors are updated (e.g., as a result of step 720, described further below, or as a result of updated third embedding vectors having been provided by a separate computing device or a separate model).

In step 706, the processing system determines if the third set of combination coefficients indicates that a given basis model of the first plurality of basis models is needed that is not included in the partitioned model. If so, the processing system will then retrieve (e.g., from a computing device hosting the full model, a remote storage system, etc.) a copy of the given basis model from the first plurality of basis models and include the given basis model in the second plurality of basis models. Likewise, in step 708, the processing system determines if the third set of combination coefficients indicates that a given basis model of the second plurality of basis models is not needed. If so, the process system will then remove the given basis model from the second plurality of basis models. Thus, if the third embedding vector identified in step 704 indicates that a different collection of basis models is needed in order to generate an output in each layer of the partitioned model, the processing system will add and subtract basis models from the second plurality of basis models according to steps 706 and 708. As already noted, this may occur in situations where a lightweight model (e.g., lightweight model 404 of FIG. 4A) or a learned embedding function (e.g., embedding function 405 of FIG. 4B) is used to identify the third embedding vector in step 704, or where a separate computing device or a separate model provides periodic updates to the third embedding vector. In addition, like method 600, method 700 may also be used to update the second plurality of basis models where the modification of one or more parameters of the partitioned model (in step 720, described below) results in changes to one or more preselected third embedding vectors. Here as well, although a given basis model may be removed from the second plurality of basis models, in some aspects of the technology, the processing system may be configured to retain a cached copy of the given basis model for some period of time (e.g., until method 700 is concluded) to avoid having to re-acquire it if further training results in the given basis model being needed again.

In step 710, the partitioned model generates an output from each given layer of the one or more layers of the partitioned model, the output for the given layer being based upon a second plurality of basis models of the given layer, the third embedding vector identified for the given layer, and the given second training example or an output of another layer of the one or more layers of the partitioned model. Step 710 is identical to step 606 of FIG. 6, and thus may be understood as described above with respect to FIG. 6.

In step 712, the partitioned model generates a second prediction based on one or more of the generated outputs. Step 712 is identical to step 608 of FIG. 6, and thus may be understood as described above with respect to FIG. 6.

In step 714, the processing system compares the second prediction (of step 608) to the given second training example to generate a second loss value. Step 714 is identical to step 610 of FIG. 6, and thus may be understood as described above with respect to FIG. 6.

In step 716, the processing system determines if there are further training examples in the batch. As shown by the “yes” arrow, if the processing system determines in step 716 that there are further training examples in the batch, it will proceed to step 718. In step 718, the processing system will select the next given second training example from the batch, and then repeat steps 704-716 for that newly selected training example. This process will then be repeated for each next given second training example of the batch until the processing system determines, at step 716, that there are no further training examples in the batch, and thus proceeds to step 718 (as shown by the “no” arrow). Steps 716 and 718 are identical to steps 612 and 614 of FIG. 6, and thus may be understood as described above with respect to FIG. 6.

As shown in step 720, after a “second loss value” has been generated (in step 714) for every given second training example in the batch, the processing system modifies one or more parameters of the partitioned model based at least in part on the generated second loss values. Step 720 is identical to step 616 of FIG. 6, and thus may be understood as described above with respect to FIG. 6. Thus, it will be understood that the modification of one or more parameters may result in changes being made to one or more preselected third embedding vectors used by the partitioned model, to a lightweight model incorporated into or used by the partitioned model (e.g., lightweight model 404 of FIG. 4A), to a learned embedding function incorporated into or used by the partitioned (e.g. embedding function 405 of FIG. 4B), and/or to any other parameters of the partitioned model.

Here as well, although step 720 describes modifying one or more parameters of the partitioned model, in some aspects of the technology, the processing system may be further configured to make the same (or similar changes) to the parameters of a separate full model based on the generated second loss values. For example, in some aspects of the technology, method 700 may be run on two or more partitioned models, each having a different subset of basis models. In such a case, each partitioned model may follow method 700 to generate second loss values, and to modify its respective parameters based thereon. In addition, each partitioned model may be configured to share its second loss values, its modified parameters, and/or the training gradients used to modify its parameters, with a separate full model, so that the same or similar changes can be made to the parameters of the full model. In this way, it is possible to split the full set of basis models of the full model into multiple partitioned models, and train the full model in a federated manner based on what is learned by each of the partitioned models.

In step 722, the processing system determines if there are further batches in the plurality of second training examples. Here as well, where the plurality of second training examples has not been broken up, and there is thus one single “batch” containing every second training example in the plurality of second training examples, the determination in step 722 will automatically be “no,” and method 700 will then end as shown in step 726. However, where the plurality of second training examples has been broken into two or more batches, the processing system will follow the “yes” arrow to step 724 to select the next given second training example from the training set. This will then start another set of passes through steps 704-718 for each training example in the next batch and another modification of one or more parameters of the partitioned model in step 720. This process will continue until there are no further batches remaining, at which point the processing system will follow the “no” arrow to step 726.

Here as well, although method 700 is shown as ending in step 726 once all second training examples of the plurality of second training examples have been used to tune the parameters of the partitioned model, it will be understood that method 700 may be repeated any suitable number of times using the same plurality of second training examples until each of its second predictions are sufficiently close to the ground truth of each respective second training example. In that regard, in some aspects of the technology, the processing system may be configured to repeat method 700 for the plurality of second training examples some predetermined number of times. Further, in some aspects, the processing system may be configured to aggregate all of the second loss values generated during a given pass through method 700, and determine whether to repeat method 700 for the plurality of second training examples based on that aggregate loss value. For example, in some aspects of the technology, the processing system may be configured to repeat method 700 for the plurality of second training examples if the aggregate loss value for the most recent pass through method 700 was greater than some predetermined threshold. Likewise, in some aspects, the processing system may be configured to use gradient descent, and to thus repeat method 700 for the plurality of second training examples until the aggregate loss value on a given pass through method 700 is equal to or greater than the aggregate loss value from the pass before it.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of exemplary systems and methods should be taken by way of illustration rather than by way of limitation of the subject matter defined by the claims. In addition, the provision of the examples described herein, as well as clauses phrased as “such as,” “including,” “comprising,” and the like, should not be interpreted as limiting the subject matter of the claims to the specific examples; rather, the examples are intended to illustrate only some of the many possible embodiments. Further, the same reference numbers in different drawings can identify the same or similar elements.

1. A computer-implemented method, comprising:
training a full model having one or more layers, each layer of the one or more layers of the full model having a first plurality of basis models, wherein the training comprises:
for each given first training example of a set of first training examples:
identifying, using one or more processors of a processing system, a first embedding vector for each layer of the one or more layers of the full model based on the given first training example, each identified first embedding vector comprising a first set of combination coefficients;
processing, using the one or more processors, the first embedding vector identified for each layer to generate a second embedding vector for each layer, each generated second embedding vector comprising a second set of combination coefficients, at least a predetermined number of combination coefficients in the second set of combination coefficients having a value of zero;
generating, using the full model, an output from each given layer of the one or more layers of the full model, the output for the given layer being based upon the first plurality of basis models of the given layer, the second embedding vector generated for the given layer, and the given first training example or an output of another layer of the one or more layers of the full model;
generating, using the full model, a first prediction based on one or more of the generated outputs; and
comparing, using the one or more processors, the first prediction to the given first training example to generate a first loss value; and
modifying, using the one or more processors, one or more parameters of the full model based at least in part on the generated first loss values.

2. The method of claim 1, wherein, for each given layer of the one or more layers of the full model, the first set of combination coefficients includes a combination coefficient associated with each basis model of the first plurality of basis models of the given layer.

3. The method of claim 1, wherein generating the output from the given layer comprises, for each given basis model of the first plurality of basis models of the given layer:
generating a first vector from the given basis model based on the given first training example or an output of another layer of the one or more layers of the full model; and
modifying the first output using one of the combination coefficients of the second set of combination coefficients of the second embedding vector generated for the given layer to generate a second vector.

4. The method of claim 3, wherein generating the output from the given layer further comprises combining each second vector generated for each basis model of the first plurality of basis models of the given layer.

5. The method of claim 4, wherein each second vector generated for each basis model of the first plurality of basis models of the given layer comprises is combined using a linear combination.

6. The method of claim 1, wherein the full model further includes a first lightweight model or a first embedding function, and
wherein the first lightweight model or the first embedding function is configured to identify the first embedding vector for each layer of the one or more layers of the full model.

7. The method of claim 1, further comprising:
training a partitioned model having one or more layers, each given layer of the one or more layers of the partitioned model having a second plurality of basis models that is a subset of the first plurality of basis models for the given layer, wherein the training comprises:
for each given second training example of a set of second training examples:
identifying, using the one or more processors, a third embedding vector for each layer of the one or more layers of the partitioned model, each identified third embedding vector comprising a third set of combination coefficients, at least a predetermined number of combination coefficients in the third set of combination coefficients having a value of zero;
generating, using the partitioned model, an output from each given layer of the one or more layers of the partitioned model, the output for the given layer being based upon the second plurality of basis models of the given layer, the third embedding vector identified for the given layer, and the given second training example or an output of another layer of the one or more layers of the partitioned model;
generating, using the partitioned model, a second prediction based on one or more of the generated outputs; and
comparing, using the one or more processors, the second prediction to the given second training example to generate a second loss value; and
modifying, using the one or more processors, one or more parameters of the partitioned model based at least in part on the generated second loss values.

8. The method of claim 7, wherein the partitioned model further includes a second lightweight model or a second embedding function, and
wherein the second lightweight model or the second embedding function is configured to identify the third embedding vector for each layer of the one or more layers of the partitioned model.

9. The method of claim 8, wherein modifying one or more parameters of the partitioned model based at least in part on the generated second loss values comprises modifying one or more parameters of the second lightweight model or the second embedding function.

10. The method of claim 7, wherein the partitioned model further includes a set of third embedding vectors and data associating a third embedding vector of the set of third embedding vectors with each layer of the one or more layers of the partitioned model, and
wherein identifying the third embedding vector for each layer of the one or more layers of the partitioned model comprises selecting the third embedding vector associated with each layer of the one or more layers of the partitioned model based on the data.

11. The method of claim 10, wherein the set of third embedding vectors includes a single third embedding vector, and the data associates the single third embedding vector with every layer of the one or more layers of the partitioned model.

12. The method of claim 7, wherein modifying one or more parameters of the partitioned model based at least in part on the generated second loss values comprises modifying one or more of the third embedding vectors.

13. The method of claim 12, further comprising:
determining, using the one or more processors, that modifying one or more parameters of the partitioned model based at least in part on the generated second loss values results in a given combination coefficient of the third set of combination coefficients changing in value from zero to a non-zero value;
retrieving, using the one or more processors, a copy of a given basis model of the first plurality of basis models based on the given combination coefficient changing in value from zero to a non-zero value; and
including the given basis model in the second plurality of basis models.

14. The method of claim 13, wherein the one or more processors are configured to retrieve the copy of the given basis model from a device storing the full model.

15. The method of claim 12, further comprising:
determining, using the one or more processors, that modifying one or more parameters of the partitioned model based at least in part on the generated second loss values results in a given combination coefficient of the third set of combination coefficients changing in value from a non-zero value to zero; and
removing, using the one or more processors, a given basis model from the second plurality of basis models based on the given combination coefficient changing in value from a non-zero value to zero.

16. The method of claim 15, further comprising:
caching, using the one or more processors, a copy of the given basis model.

17. A computer-implemented method, comprising:
training a partitioned model having one or more layers, each given layer of the one or more layers of the partitioned model having a first plurality of basis models, wherein the training comprises:
for each given first training example of a set of first training examples:
identifying, using one or more processors of a processing system, a first embedding vector for each layer of the one or more layers of the partitioned model, each identified first embedding vector comprising a first set of combination coefficients, at least a predetermined number of combination coefficients in the first set of combination coefficients having a value of zero;
generating, using the partitioned model, an output from each given layer of the one or more layers of the partitioned model, the output for the given layer being based upon the first plurality of basis models of the given layer, the first embedding vector identified for the given layer, and the given first training example or an output of another layer of the one or more layers of the partitioned model;
generating, using the partitioned model, a first prediction based on one or more of the generated outputs; and
comparing, using the one or more processors, the first prediction to the given first training example to generate a first loss value; and
modifying, using the one or more processors, one or more parameters of the partitioned model based at least in part on the generated first loss values.

18. The method of claim 17, wherein the partitioned model further includes a first lightweight model or a first embedding function, and
wherein the first lightweight model or the first embedding function is configured to identify the first embedding vector for each layer of the one or more layers of the partitioned model.

19. The method of claim 18, wherein modifying one or more parameters of the partitioned model based at least in part on the generated first loss values comprises modifying one or more parameters of the first lightweight model or the first embedding function.

20. The method claim 17, wherein the partitioned model further includes a set of first embedding vectors and data associating a first embedding vector of the set of first embedding vectors with each layer of the one or more layers of the partitioned model, and
wherein identifying the first embedding vector for each layer of the one or more layers of the partitioned model comprises selecting the first embedding vector associated with each layer of the one or more layers of the partitioned model based on the data.

21. The method of claim 20, wherein the set of first embedding vectors includes a single first embedding vector, and the data associates the single first embedding vector with every layer of the one or more layers of the partitioned model.

22. The method of claim 17, wherein modifying one or more parameters of the partitioned model based at least in part on the generated first loss values comprises modifying one or more of the first embedding vectors.

23. The method of claim 22, further comprising:
determining, using the one or more processors, that modifying one or more parameters of the partitioned model based at least in part on the generated first loss values results in a given combination coefficient of the first set of combination coefficients changing in value from zero to a non-zero value;
retrieving, using the one or more processors, a copy of a given basis model based on the given combination coefficient changing in value from zero to a non-zero value; and
including the given basis model in the first plurality of basis models.

24. The method of claim 23, wherein the one or more processors are configured to retrieve the copy of the given basis model from a device storing a second plurality of basis models.

25. The method of claim 22, further comprising:
determining, using the one or more processors, that modifying one or more parameters of the partitioned model based at least in part on the generated first loss values results in a given combination coefficient of the first set of combination coefficients changing in value from a non-zero value to zero; and
removing, using the one or more processors, a given basis model from the first plurality of basis models based on the given combination coefficient changing in value from a non-zero value to zero.

26. The method of claim 25, further comprising:
caching, using the one or more processors, a copy of the given basis model.

27. The method of claim 17, wherein modifying one or more parameters of the partitioned model based at least in part on the generated first loss values comprises modifying one or more of the first embedding vectors to generate a second embedding vector for each layer of the one or more layers of the partitioned model, each second embedding vector comprising a second set of combination coefficients, at least a predetermined number of combination coefficients in the second set of combination coefficients having a value of zero, and
wherein the method further comprises, for each given first inference task of a set of first inference tasks:
generating, using the partitioned model, a first output from each given layer of the one or more layers of the partitioned model, the first output for the given layer being based upon the first plurality of basis models of the given layer, the second embedding vector generated for the given layer, and the given first inference task or a first output of another layer of the one or more layers of the partitioned model; and
generating, using the partitioned model, a second prediction based on one or more of the generated first outputs.

28-31. (canceled)
